(19) United States
(12) Patent Application Publication
(10) Pub. No.: US 2020/0349661 A1
(43) Pub. Date: Nov. 5, 2020

(54) BUILDING SYSTEM WITH SMART BUILDING SCORING

(71) Applicant: Johnson Controls Technology Company, Auburn Hills, MI (US)

(72) Inventors: Pranjal Dutta, Assam (IN); Diptiranjan Swain, Odisha (IN); Mangesh A. Dhawale, Maharashtra (IN); Anish P. Krishnamurthy, Kerala (IN); Tulshiram Waghmare, Maharashtra (IN)

(73) Assignee: Johnson Controls Technology Company, Auburn Hills, MI (US)

(21) Appl. No.: 16/399,698

(22) Filed: Apr. 30, 2019

(51) Int. Cl. G06Q 50/16; G06Q 30/00

(52) U.S. Cl. CPC G06Q 50/163; G06Q 30/018

(57) ABSTRACT

Systems and methods described herein related to a method for a building analytics system of a building conducted by a processing circuit. The method includes receiving an input comprising a plurality of building values from a building network, wherein each value of the plurality of building values is associated with a one of a plurality of building characteristics. The method includes identifying a plurality of rules based on the plurality of building values, wherein each of the plurality of rules is associated with one of the plurality of building characteristics and determining a plurality of scores based on the plurality of rules and the plurality of building values, wherein each score of the plurality of scores is associated with one of the plurality of building characteristics. The method includes generating a building score based on the plurality of scores, wherein the building score identifies a performance level of the building.

### BACKGROUND

The present disclosure relates generally to the field of building management systems. A building management system (BMS) is, in general, a system of devices configured to control, monitor, and manage equipment in or around a building or building area. A BMS can include, for example, a heating, ventilation, and air conditioning (HVAC) system, a security system, a lighting system, a fire alerting system, any other system that is capable of managing building functions or devices, or any combination thereof.

Current building management systems do not have a way of determining if the building management systems, or buildings, are operating as effectively and as efficiently as they could be. While the building management systems can identify and analyze the impact and efficiency of different devices within each building management system, there is not currently a system that can take all of the data associated with a building and provide a meaningful output representing how a building is operating as a whole. For example, current systems may provide comparison/benchmarking between similar buildings according to size, type of building, climate zone etc., but each comparison is done independently of each other and does not give an output showing how a building management system that is being compared/benchmarked is performing as a whole. Further, building management systems do not have a way to use other vital characteristics of buildings to let users know how the building management systems are operating. Characteristics of building management systems such as equipment performance, occupant comfort, indoor environment quality, sub level energy consumption, and smart building features are ignored because data associated with them cannot be easily manipulated, used, or organized. Consequently, building management systems let information related to how a building is operating and where there are potential areas of improvement go unused. Thus, a solution is needed to determine how to collect data so a user can determine how a building is operating and be able to adjust configurations of equipment of the building accordingly.

Further, because current building management systems cannot collect specific types of data and organize the data in a meaningful manner, the building management systems cannot use the data to determine new configurations for building equipment, such as HVAC equipment, to help improve how each building management system is operating. All it may take to improve the energy efficiency of a building is an AHU operating one less hour every day, but building management systems do not have a way of identifying this potential improvement. Thus, not only is a solution needed to determine how to collect the data, but also how to use the collected data to determine new configurations for devices in building management systems.

### SUMMARY

One implementation of the present disclosure is a method for a building analytics system of a building conducted by a processing circuit. The method includes receiving an input including building values from a building network, wherein each value of the building values is associated with a one of the building characteristics. The method includes identifying multiple rules based on the building values, wherein each of the rules is associated with one of the building characteristics. The method includes determining scores based on the rules and the building values. Each score of the scores is associated with one of the building characteristics. The method includes generating a building score based on the scores. The building score identifies a performance level of the building.

In some embodiments, the characteristics include at least one of energy performance, indoor environment quality, renewable energy, water management, space management, HVAC, lighting, access control, fire and safety, security and intrusion, lifts, visitor management, or smart parking.

In some embodiments, each rule of the rules is tagged with a building equipment tag representing one of the building characteristics, wherein each of the building characteristics is associated with a particular equipment system of the building.

In some embodiments, each value of the values is associated with an adjustable time period.

In some embodiments, identifying the scores is based on average values associated with the adjustable time period.

In some embodiments, generating the building score based on the scores includes aggregating the scores to determine an aggregated score value and generating the smart building score based on the aggregated score value by comparing the aggregated score value to one or more thresholds.

In some embodiments the smart building score based on the aggregated score value by comparing the aggregated value to the one or more thresholds includes determining whether the aggregated value is below a second threshold of the one or more thresholds wherein the method includes identifying a portion of the rules to improve to obtain higher second values associated with each second rule. The method includes identifying configurations for one or more pieces of building equipment associated with the portion of the rules so the aggregated value is above the at least one second threshold, wherein the one or more of building equipment are identified based on building equipment tags associated with the portion of the rules. The method includes generating a signal to transmit to the building equipment including the configuration of each piece of building equipment.

In some embodiments, the building analytics system determines the scores after retrieving all of the values of the values that are associated with the adjustable time period.

In some embodiments, each rule of the rules includes conditions, each condition associated with a particular range or value.

In some embodiments, determining scores includes identifying each condition for each rule of the rules; identifying building values associated with each condition; and determining which conditions have been met for each rule of the rules based on the identified conditions and building values.

In another implementation of the present disclosure, a building analytics system of a building is disclosed. The building analytics system includes a processing circuit configured to receive an input including building values from a building network, wherein each value of the building values is associated with one of multiple building characteristics and identify multiple of rules based on the building values. Each of the rules is associated with one of the building characteristics. The processing circuit is configured to determine multiple scores based on the rules and the building values. Each score of the scores is associated with one of the building characteristics. The building analytics system is configured to generate a building score based on the scores, wherein the building score identifies a performance level of the building.

In some embodiments, the characteristics include at least one of energy performance, indoor environment quality, renewable energy, water management, space management, HVAC, lighting, access control, fire and safety, security and intrusion, lifts, visitor management, or smart parking.

In some embodiments, each rule of the rules is tagged with a building equipment tag representing one of the building characteristics, wherein each of the building characteristics is associated with a particular equipment system of the building.

In some embodiments, each value of the values is associated with an adjustable time period.

In some embodiments, the processing circuit is configured to identify the scores based on average values associated with the adjustable time period.

In some embodiments, the processing circuit is configured to generate the building score by aggregating the scores to determine an aggregated score value and generating the building score based on the aggregated score value by comparing the aggregated score value to one or more thresholds.

In some embodiments the processing circuit is configured to generate the building score by determining whether the aggregated value is below a second threshold of the one or more thresholds. The processor is configured to identify a portion of the rules to improve to obtain higher second values associated with each second rule and identify configurations for one or more pieces of building equipment associated with the portion of the rules so the aggregated value is above the at least one second threshold. The one or more of building equipment are identified based on building equipment tags associated with the portion of the rules. The processing circuit is configured to generate a signal to transmit to the building equipment including the configuration of each piece of building equipment.

In some embodiments, each rule of the rules includes multiple conditions, each condition associated with a particular range or value.

In some embodiments, the processing circuit is configured to determine the scores by identifying each condition for each rule of the rules, identifying building values associated with each condition, and determining which conditions have been met for each rule of the rules based on the identified conditions and building values.

In another implementation of the present disclosure, a non-transitory computer-readable storage medium having instructions stored thereon that, upon execution by a processor, cause the processor to perform operations to generate a building score is disclosed. The operations including receiving an input including multiple building values from a building network, wherein each value of the building values is associated with one of multiple building characteristics and identifying multiple rules based on the building values, wherein each of the rules is associated with one of the building characteristics. The operations including determining multiple scores based on the rules and the building values, wherein each score of the scores is associated with one of the building characteristics and generating a building score based on the scores, wherein the building score identifies a performance level of the building.

In some embodiments, the processor generates the building score by determining whether the aggregated value is below a second threshold of the one or more thresholds. The operations include aggregating the plurality of scores to determine an aggregated score value and generating the building score based on the aggregated score value by comparing the aggregated score value to one or more thresholds. The operations include identifying a portion of the rules to improve to obtain higher second values associated with each second rule and identifying configurations for one or more pieces of building equipment associated with the portion of the rules so the aggregated value is above the at least one second threshold, wherein the one or more pieces of building equipment are identified based on building equipment tags associated with the portion of the rules. The operations include generating a signal to transmit to the building equipment comprising the configuration of each piece of building equipment.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with an HVAC system, according to an exemplary embodiment.

FIG. 2 is a schematic of a waterside system, which can be used as part of the HVAC system of FIG. 1, according to an exemplary embodiment.

FIG. 3 is a block diagram of an airside system, which can be used as part of the HVAC system of FIG. 1, according to an exemplary embodiment.

FIG. 4 is a block diagram of a BMS which can be used in the building of FIG. 1, according to an exemplary embodiment.

FIG. 5 is a block diagram of a building scoring system in communication with a building network configured to receive data associated with pieces of building equipment and generate a smart building score based on the received data and rules of a rule database, according to an exemplary embodiment.

FIG. 6A is a table showing an energy use rule table within the rule database of FIG. 5 that can be used to determine the smart building score, according to an exemplary embodiment.

FIG. 6B is an energy performance rule table within the rule database of FIG. 5 that can be used to determine the smart building score, according to an exemplary embodiment.

FIG. 6C is an indoor environment quality rule table within the rule database of FIG. 5 that can be used to determine the smart building score, according to an exemplary embodiment.

FIG. 6D is a renewable energy rule table within the rule database of FIG. 5 that can be used to determine the smart building score, according to an exemplary embodiment.

FIG. 6E is a water management rule table within the rule database of FIG. 5 that can be used to determine the smart building score, according to an exemplary embodiment.

FIG. 6F is a space utilization rule table within the rule database of FIG. 5 that can be used to determine the smart building score, according to an exemplary embodiment.

FIG. 6G is an HVAC rule table within the rule database of FIG. 5 that can be used to determine the smart building score, according to an exemplary embodiment.

FIG. 6H is a lighting rule table within the rule database of FIG. 5 that can be used to determine the smart building score, according to an exemplary embodiment.

FIG. 6I is an access control rule table within the rule database of FIG. 5 that can be used to determine the smart building score, according to an exemplary embodiment.

FIG. 6J is a fire and safety rule table within the rule database of FIG. 5 that can be used to determine the smart building score, according to an exemplary embodiment.

FIG. 6K is a security and intrusion rule table within the rule database of FIG. 5 that can be used to determine the smart building score, according to an exemplary embodiment.

FIG. 6L is a lifts rule table within the rule database of FIG. 5 that can be used to determine the smart building score, according to an exemplary embodiment.

FIG. 6M is a personalized workplace rule table within the rule database of FIG. 5 that can be used to determine the smart building score, according to an exemplary embodiment.

FIG. 6N is a visitor management rule table within the rule database of FIG. 5 that can be used to determine the smart building score, according to an exemplary embodiment.

FIG. 6O is smart parking rule table within the rule database of FIG. 5 that can be used to determine the smart building score, according to an exemplary embodiment.

FIG. 7 is a schematic diagram of a scorecard displaying the smart building score that can be included in a user interface, according to an exemplary embodiment.

FIG. 8 is a report of scores associated with performance of a smart building that can be included in a user interface, according to an exemplary embodiment.

FIG. 9 is a flow chart of a process of receiving inputs, associating the inputs with a rule, and generating a smart building score based on the inputs, according to an exemplary embodiment.

FIG. 10 is a flow chart of a process of using a smart building score to generate new configurations for different pieces of building equipment, according to an exemplary embodiment.

FIG. 11 is a flow diagram of a process including steps performing different rules execution and data categorization to determine a smart building score, according to an exemplary embodiment.

### DETAILED DESCRIPTION

### Overview

Referring generally to the FIGURES, systems and methods of a building system with smart building scoring are shown, according to various exemplary embodiments. For many building management systems, it is important to understand how the building system is operating and where there are potential areas of improvement. The building management system is configured to use data identifying the potential areas of improvement to identify building equipment related to the areas of improvement and new configurations for the building equipment so the building system can perform better as a whole, in some embodiments. Because building management systems operate in a complicated environment with different devices impacting multiple characteristics of a building, it can be difficult to pinpoint which devices have the most negative effect on how a building is operating and what that effect is. If a building management system could identify specific devices that are not operating up to their full capabilities based on their configurations, the building management system could identify new configurations for each of these devices and send them new configurations. In turn, each device could operate more efficiently, improving the efficiency of the building management system as a whole.

The building management system as described herein utilizes a building analytics system to identify scores associated with different characteristics of a building and an aggregated total of the scores to obtain a smart building score. The smart building score can be an overall representation of how “smart” a building is compared to other similar buildings (e.g. similar sized residential buildings, similar purposed commercial buildings, retail buildings, etc.). The building analytics system can identify the scores by applying rules to values associated with each characteristic. Once the smart building score is calculated, the building analytics system can use the scores from each rule to determine new configurations for building devices associated with each rule.

The building management system as described herein is configured to, upon a request from a user or automatically, identify a smart building score based on scores associated with different characteristics of a building, in some embodiments. To determine scores for each characteristic, the building management system can be configured to retrieve or receive values from sensors collecting data associated with each characteristic. The building management system can be configured to determine which rules to associate with the values based on building characteristic tags associated with the rules and/or values that indicate which building characteristic the rules and/or values are associated with. The building management can be configured to match rules with characteristics that share a similar building characteristic tag, in some embodiments.

The building management system determines which rule and values are related to the same building characteristic, the building management system can apply conditions and/or thresholds associated with the rule and value to determine how many points to associate with the rule. For example, a building management system can receive values related to an energy use intensity of a building. The values can be taken and transmitted from sensors that that retrieve data from each device associated with the building indicating how much energy each device uses. The building management system can identify that the values are related to energy use based on a building characteristic tag associated with each value. The building management system is configured to compare the temperature values to thresholds and/or conditions associated with a rule related to energy use to determine how many points that particular rule is worth. In some embodiments, thresholds and conditions are similar. In some embodiments, a condition can indicate whether a system is in a building or not while a threshold can be used to indicate whether a value is above or below a certain value. Conditions and thresholds can be used interchangeably. In some embodiments, the building management system uses an average of the values associated with the same building characteristic. The building management system can repeat these steps for each building characteristic until determining a score for each rule. After determining scores for each rule, the building management system can aggregate the scores to determine a smart building score.

In some embodiments, the building management system is configured to determine a smart building score based on a user defined time period, in some embodiments. In some embodiments, in response to receiving a request for a smart building score for a selected time period, the building management system is configured receive or retrieve values associated with each building characteristic based on time stamps associated with each value. The time stamps may be associated with each value upon receipt of the value at the particular time and may be determined either by the building management system based on when each value was received, or by a sensor that generated the value. To determine a smart building score over a user defined time period, the building management system can be configured take an average of all of the values retrieved or received with the time stamp and determine scores for each building characteristic using rules similar to above, in some embodiments. Users can obtain a smart building score for any time frame.

After obtaining a smart building score, the building management system can be configured to use the building score and the data collected to obtain the building score to generate new configurations for building equipment, in some embodiments. The building management system can be configured to generate new configurations for building equipment that is correlated with poor performance related a particular building characteristic (i.e. a building characteristic may have a poor score compared to other building characteristics), in some embodiments. The building management system can be configured to identify building equipment to generate new configurations for based on tags indicating which building equipment is associated with the building characteristic that scored poorly, in some embodiments. Once the building management system identifies the building equipment, the building management system can identify a new configuration to improve the score of the characteristic that the building equipment is associated with.

Advantageously, by using the systems and methods described, building management systems can quickly generate smart building scores for buildings over any period of time and use the smart building scores to change the configurations of building equipment that can perform better if their configurations received an adjustment. The building management can be configured to automatically identify building equipment and new configurations using data that previously had no use to improve the overall efficiency and operation of a building and the building management system of the building, in some embodiments.

### Building and HVAC System

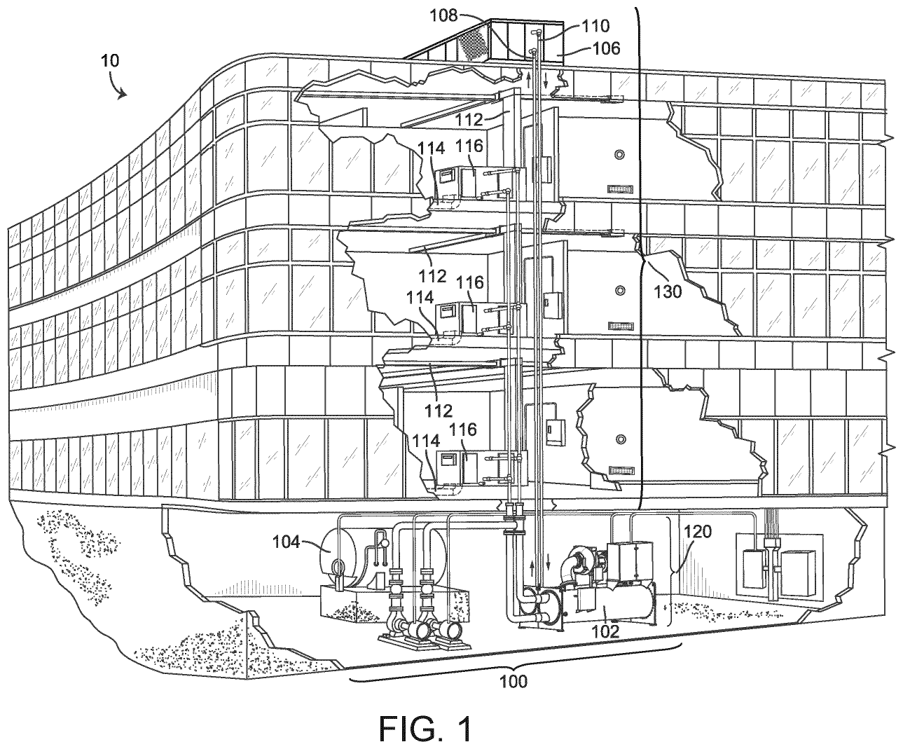

Referring now to FIGS. 1-3, an exemplary HVAC system in which the systems and methods of the present disclosure can be implemented are shown, according to an exemplary embodiment. While the systems and methods of the present disclosure are described primarily in the context of a building HVAC system, it should be understood that the control strategies described herein can be generally applicable to any type of control system.

Referring particularly to FIG. 1, a perspective view of a building 10 is shown. Building 10 is served by a building management system (BMS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

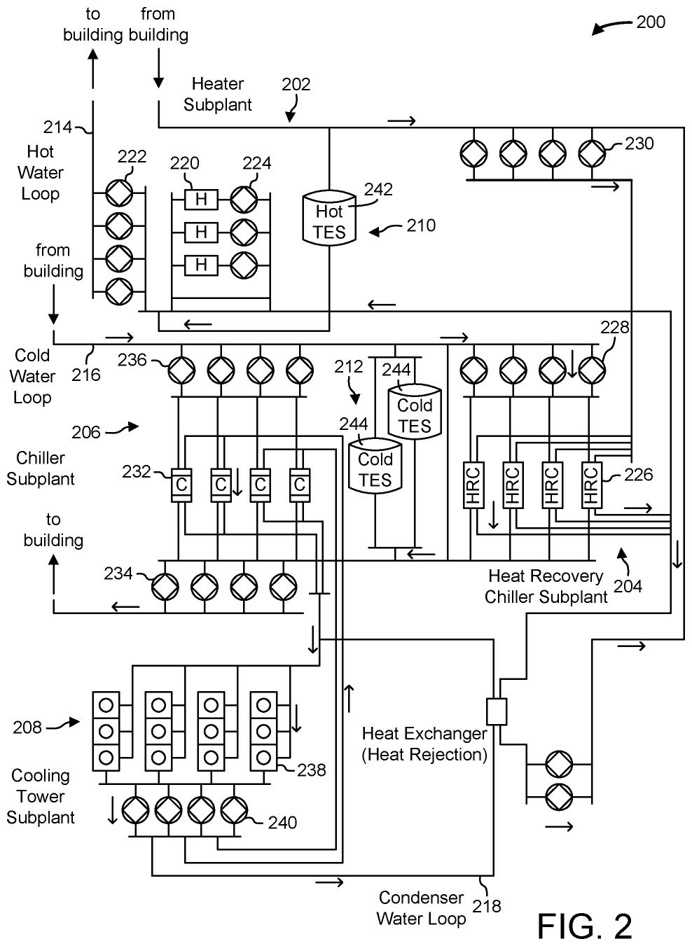

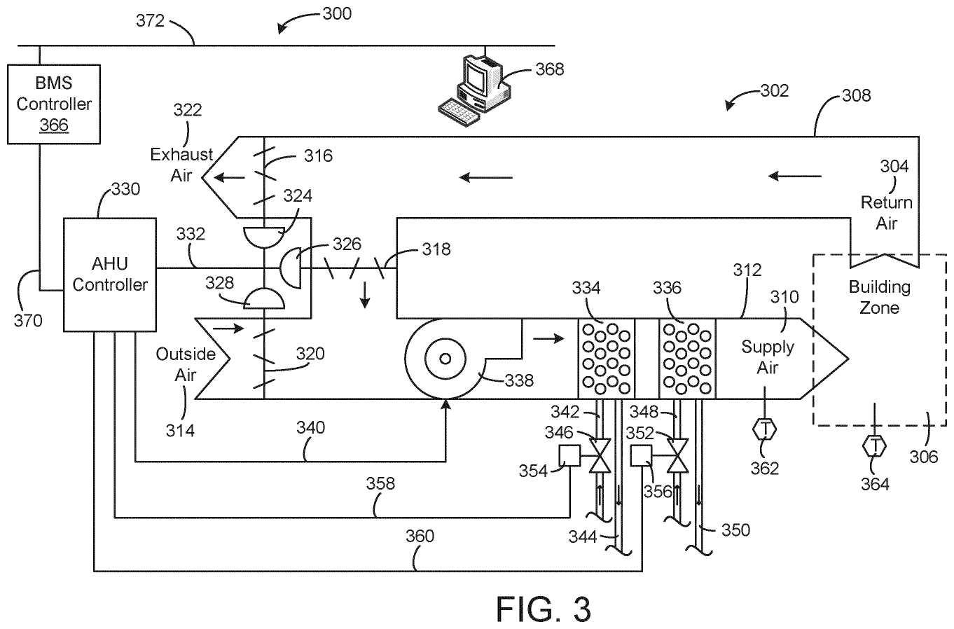

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve set-point conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 and the building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive return air 304 and outside air 314. AHU 302 can be configured to operate an exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust air damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to AHU controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a set-point temperature for supply air 310 or to maintain the temperature of supply air 310 within a set-point temperature range). The positions of valves 346 and 352 affect the amount of heating or cooling provided to supply air 310 by heating coil 336 or cooling coil 334 and can correlate with the amount of energy consumed to achieve a desired supply air temperature. AHU controller 330 can control the temperature of supply air 310 and/or building zone 306 by activating or deactivating coils 334-336, adjusting a speed of fan 338, or a combination thereof.

Still referring to FIG. 3, airside system 300 is shown to include a BMS controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. The AHU controller 330 can be a hardware module, a software module configured for execution by a processor of BMS controller 366, or both.

In some embodiments, AHU controller 330 receives information (e.g., commands, set points, operating boundaries, etc.) from BMS controller 366 and provides information (e.g., temperature measurements, valve or actuator positions, operating statuses, diagnostics, etc.) to BMS controller 366. For example, AHU controller 330 can provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

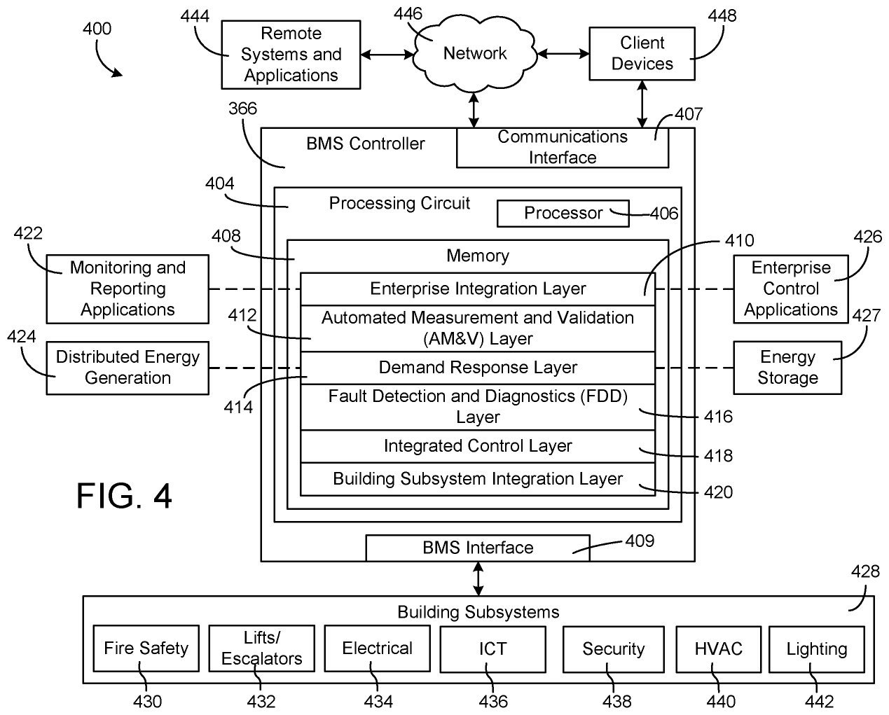

Referring now to FIG. 4, a block diagram of a building management system (BMS) 400 is shown, according to an example embodiment. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an example embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an example embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an example embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration can advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other example embodiments, FDD layer 416 is configured to provide “fault” events to integrated control layer 418 which executes control strategies and policies in response to the received fault events. According to an example embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Building Scoring System

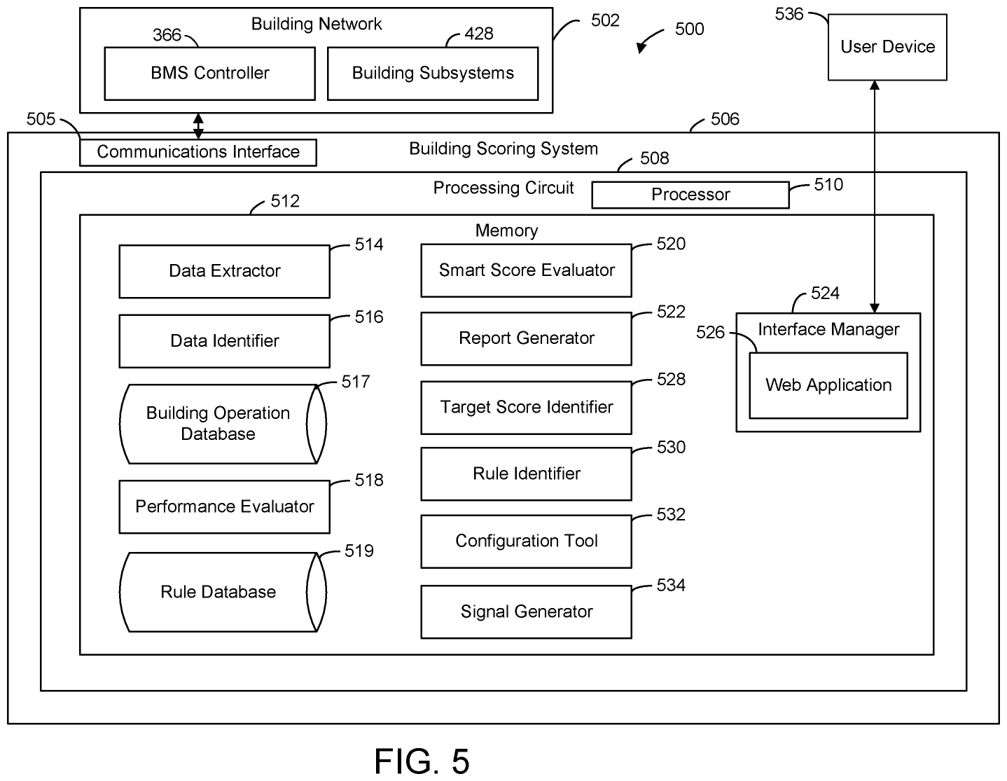

Referring now to FIG. 5, a system 500 is shown including building scoring system 506 in communication with a building network 502, according to an exemplary embodiment. Building network 502 can include BMS 400 (e.g., BMS controller 366, building subsystems 428, etc.) and/or any items (e.g., spaces, equipment, objects, points, etc.) of a building that building scoring system 506 can be associated with. Building scoring system 506 can be configured to provide various reporting capabilities regarding the items and/or facilitate providing commands (e.g., bulk commands, individual commands, etc.) to one or more of the items (e.g., spaces, equipment, objects, points, etc.) connected therewith.

As shown in FIG. 5, building scoring system 506 includes a communications interface 505 and processing circuit 508 having a processor 510 and a memory 512. Processing circuit 508 can be communicably connected to communications interface 505 such that processing circuit 508 and the various components thereof can send and receive data via communications interface 505 (e.g., to/from building network 502, etc.). Processor 510 can be implemented as a general purpose processor, an application specific integrated circuit (ASIC), one or more field programmable gate arrays (FPGAs), a group of processing components, or other suitable electronic processing components.

Memory 512 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 512 can be or include volatile memory or non-volatile memory. Memory 512 can include database components, object code components, script components, or any other type of information structure for supporting the various activities and information structures described in the present application. According to an example embodiment, memory 512 is communicably connected to processor 510 via processing circuit 508 and includes computer code for executing (e.g., by processing circuit 508 and/or processor 510) one or more processes described herein. In some embodiments, building scoring system 506 is implemented within a single computer (e.g., one server, one housing, etc.). In various other embodiments, building scoring system 506 can be distributed across multiple servers or computers (e.g., that can exist in distributed locations).

A user device 536 can be a device that is communicably coupled to components within memory 512. User device 536 can be electronic devices that can enable users to receive and transmit data and information to interface manager 524. Examples of user devices 536 include, but are not limited to, mobile phones, electronic tablets, laptops, desktop computers, televisions, cameras, and any other electronic device that can be able to attach to a network. User device 536 can be able to send requests and signals to interface manager 524 asking for data from individual components of memory 512. After sending a request, user device 536 can receive a graphical user interface from web application 526 with the requested information in a display for the user. User device 536 can display the graphical user interface to a user and accept user inputs by sending a request for a new graphical user interface to interface manager 524 after a user has selected a location on the graphical user interface. There can be any number of user devices 536 in communication with interface manager 524.

In some embodiments, user device 536 can be used by users to access an application corresponding to a web application 526 of interface manager 524 via an application downloaded on user device 536. The application can allow users at user device 536 to query memory 512 asking for reports about how a building is operating and asking for a smart building score.

Still referring to FIG. 5, memory 512 is shown to include a data extractor 514, a data identifier 516, a building operation database 517, a performance evaluator 518, a rule database 519, a smart score evaluator 520, a report generator 522, an interface manager 524, a target score identifier 528, a rule identifier 530, a configuration tool 532, and a signal generator 534. Components 514-534 can be configured to receive inputs from and/or send outputs to building network 502, user device 536, and other data sources and provide searching, reporting, and/or command capabilities.

Interface manager 524 can be one component or multiple components within memory 512 and is configured to interface with an application on user device 536. Interface manager 524 is shown to include web application 526 which can be an application that corresponds to the application on user device 536. Web application 526 can provide a graphical user interface to user device 536 that allows a user at user device 536 to input a request for data and/or a report from memory 512. Users can input any sort of request related to how a building is operating into web application 526 through user device 536.

Data extractor 514 can be a component in memory 512 that is configured to receive and/or store various types of data regarding components of building network 502 in building operation database 517. For example, data extractor 514 can have access to information regarding spaces, equipment, objects, items, points, etc., of building network 502 and the associations therebetween. Data extractor 514 can be configured to receive the information directly from the components of building subsystems 428 and/or BMS controller 366, in some embodiments.

In some embodiments, data extractor 514 is configured to receive data from building subsystems 428 at multiple points in time. The data can represent different characteristics related to a building. Data extractor 514 can receive the data after polling building network 502 requesting data gathered by various sensors in building subsystems 428. Data extractor 514 can poll building network 502 for data regarding specific sensors or for data from all of the sensors at once. Data extractor 514 can poll building network 502 at various time intervals including hourly, daily, weekly, monthly, annually or any other time period. The time intervals can also be pseudo-randomly poll building network 502. In some embodiments, users at user device 536 can manually instruct data extractor 514 to request data from sensors in building network 502. In these instances, the user can specify specific sensors to take readings from or ask for all of the available data at building network 502. Once data extractor 514 receives the data, data extractor 514 can tag the data with tags describing where the data came from (e.g. subsystem, sensor, space, etc.) and at what time and date data extractor 514 received the data. After receiving the data, data extractor 514 can store the data in building operation database 517.

Building operation database 517 can be a dynamic database including data inputs that data extractor 514 receives from building subsystems 428 and BMS controller 366. Building operation database 517 can be represented in a graph database, MySQL, Oracle, Microsoft SQL, PostgreSQL, DB2, document store, search engine, key-value store, etc. Building operation database 517 is configured to hold any amount of data and can be made up of any number of components, in some embodiments. Building operation database 517 can be organized into sections. Each section can represent inputs received from a specific sensor or subsystem. For example, building operation database 517 can include temperature inputs from a thermometer in a conference room of an office building that were received at different times throughout a year. Building operation database 517 can store the temperature inputs in a column with different data entries associated with times the temperature inputs were taken for each row. Each column in building operation database 517 can represent a different sensor within building subsystems 428 while each row can represent different time stamps representing the time and date the data was received by data extractor 514. The sections can further be broken up into subsections directed to specific areas within a building or outside of a building or any other way to break the data into subsections. Data received from building subsystems 428 can be added or removed from building operation database 517 at any time.

According to an exemplary embodiment, a user at user device 536 can attempt to obtain a smart building score through a web application 526 in interface manager 524. Web application 526 is configured to obtain the score by utilizing each of components 516, 517, 518, 519, 520, and 522 (components 516-522) of memory 512, in some embodiments. A smart building score can be a rating attributed to a dynamic algorithm to derive a performance score based on data received from building subsystems 428 and stored in building operation database 517. The smart building score can be based on multiple rules and inputs wherein the smart building score is derived from scores attributed to each input. The smart building score can represent how “smart” a building is, or how effective the building is at providing resources to occupants and autonomously performing tasks.

In some embodiments, a user at user device 536 can seek to obtain a smart building score for a specified time frame, such as one week, one month, one year, 2 years, etc. To request a smart building score for a building, a user at user device 536 can access web application 526 and input a time frame representing the time period the user wants to obtain the score for. After inputting the time frame, components 516-522 of memory 512 can store, access, and utilize data from the building in the specified time frame to produce a smart building score.

Data identifier 516 can be a component within memory 512 that is configured to identify data received from building subsystems 428 and BMS controller 366 in building operation database 517 after a smart building score is requested by a user through web application 526. Data identifier 516 can be one component or multiple components. In some embodiments, data identifier 516 is configured to scan building operation database 517 for data relevant to the request received through web application 526, in some embodiments. For example, a user can request to receive a smart building score for a building over a period of five months. Data identifier 516 can receive the request and obtain all of the data within building operation database 517 that is associated with the smart building score over the five-month period.

In some cases, a user might request specific data related to characteristics associated with building network 502. For example, a user can request to see air pressure readings in a conference room over the previous year. Data identifier 516 is configured to receive the request, access building operation database 517, scan building operation database 517 for air pressure readings over the previous year, and transmit the relevant data to web application 526 to display to the requesting user at user device 536, in some embodiments. After the user receives the data regarding the air pressure readings over the previous year, the user can input another request into web application 526 requesting more data from a different time frame, different sensors, or both.

In some embodiments, after data identifier 516 retrieves the requested data from building operation database 517, data identifier 516 can tag the data with a tag indicating which sensor the data came from. The tag can represent the type of sensor that was used to collect the data and where the sensor was located (e.g. which building, which room, which area of the room, etc.). Data identifier 516 can determine which tags to use by scanning building operation database 517 for information associated with each piece of data that it retrieves and identifying the information. For example, data identifier 516 can retrieve data associated with the temperature of a conference room. While retrieving data, data identifier 516 can identify which building, which conference room, and which area of the conference room the sensor that input the data took data measurements from. Further, data identifier 516 can identify that the information is the temperature of the room and tag the information accordingly. In some embodiments, data extractor 514 can tag the information before storing the data in building operation database 517 and data identifier 516 can identify the tags by scanning the data. Once the relevant data has been identified, data identifier 516 can send the data to performance evaluator 518 to evaluate the data.

Performance evaluator 518 can be one component or multiple components within memory 512 that is configured to evaluate data associated with different rules and associate scores with the data, in some embodiments. After receiving the data from data identifier 516, performance evaluator 518 can first identify the tags associated with each data type and the areas from which the data was received. After identifying the tags, performance evaluator 518 can assign point values to each piece of data based on rules stored in rule database 519.

Rule database 519 can be a dynamic database configured to include rule inputs received from an administrator at user device 536, in some embodiments. Rule database 519 can hold any amount of rules and can be made up of any number of components. Each rule can be tagged with a tag indicating the building equipment that can impact a score associated with each rule. Rule database 519 can be organized into sections, wherein each section represents rules for different types of data. For example, rule database 519 can include rules associated with different types of sensory inputs, such as but not limited to, energy performance, indoor environment quality, renewable energy, water management, space utilization, HVAC, lighting, access control, fire and safety, security and intrusion, lifts, personalized workplace, visitor management, smart parking, etc.

Rule database 519 can include rules implemented by a building analytics system wherein each rule can be associated with a different point value and each rule can have different conditions and/or thresholds. For example, a rule can be associated with up to 20 points if a value associated with the rule is above all thresholds and/or conditions of the rule while another rule may be associated with up to one point. If a value is below any thresholds and/or conditions, less points than the maximum can be associated with the rule. Maximum point values for rules, along with the conditions and/or thresholds associated with the point values, can be determined by a user at user device 536 and can be changed at any time.

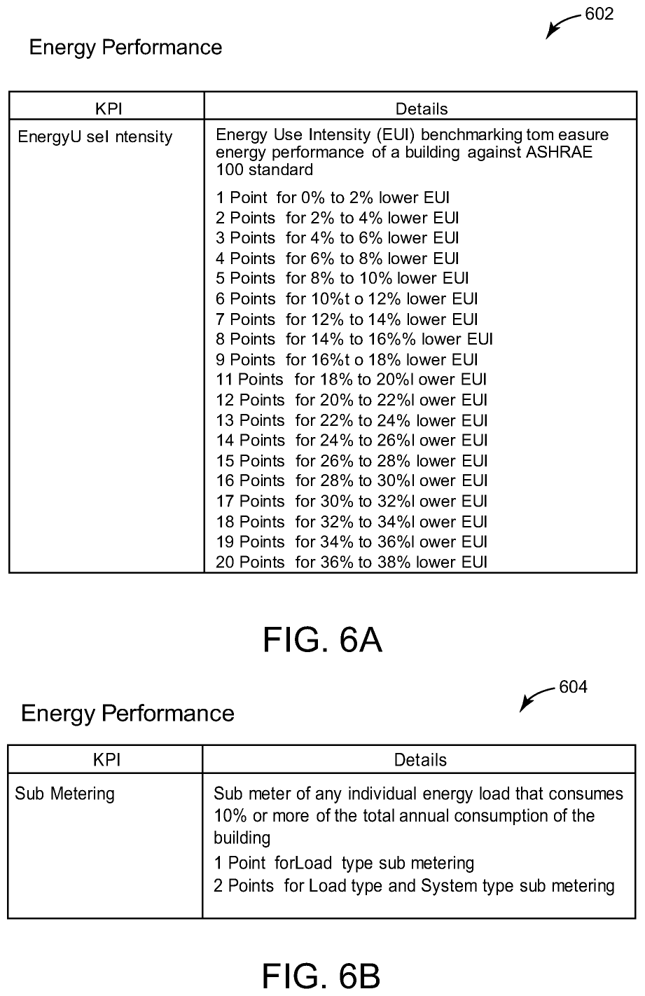

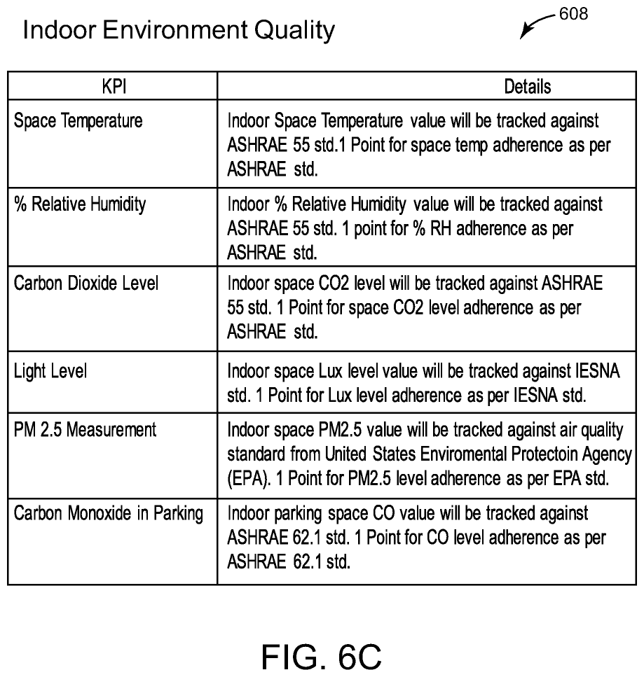

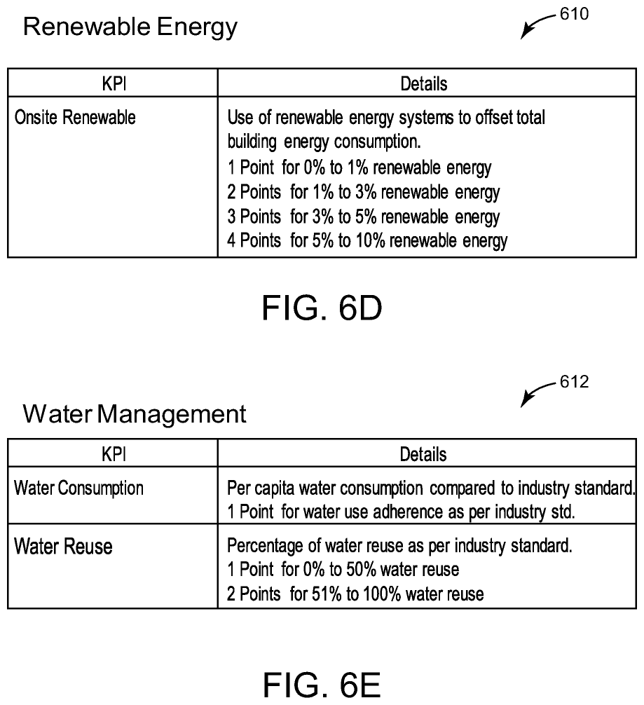

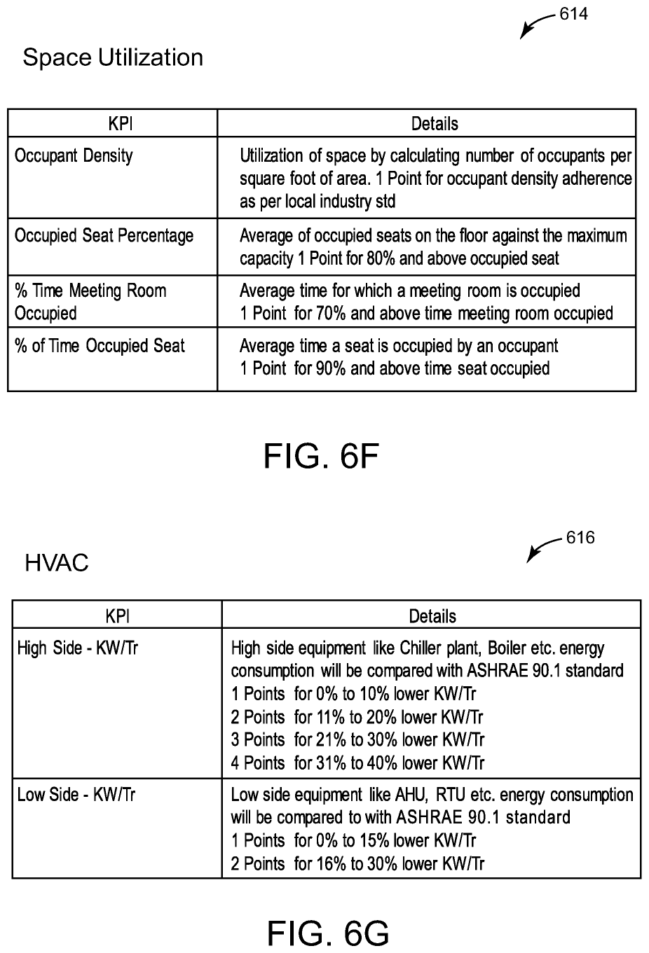

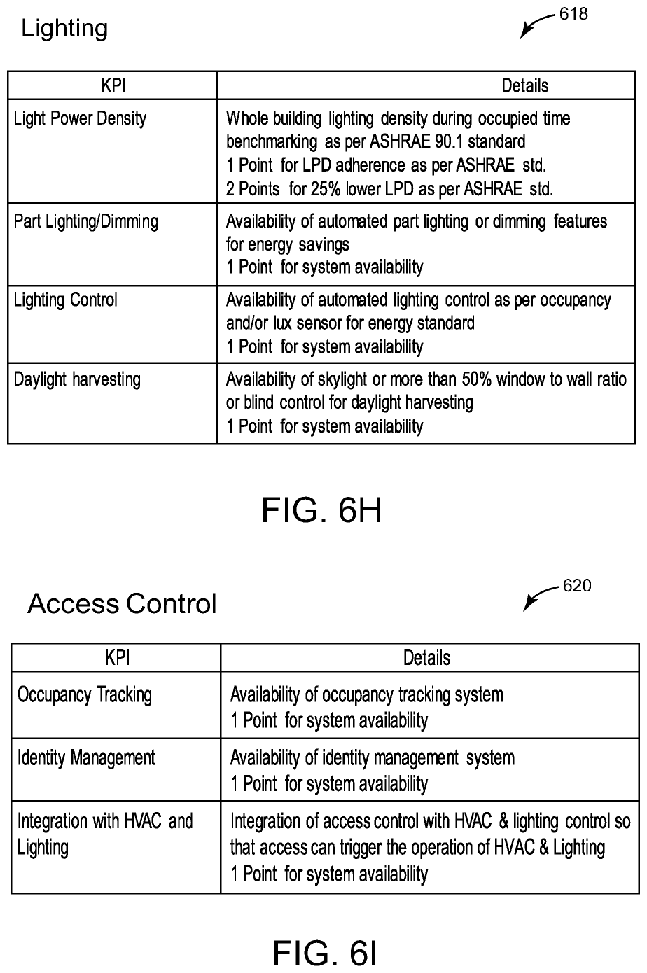

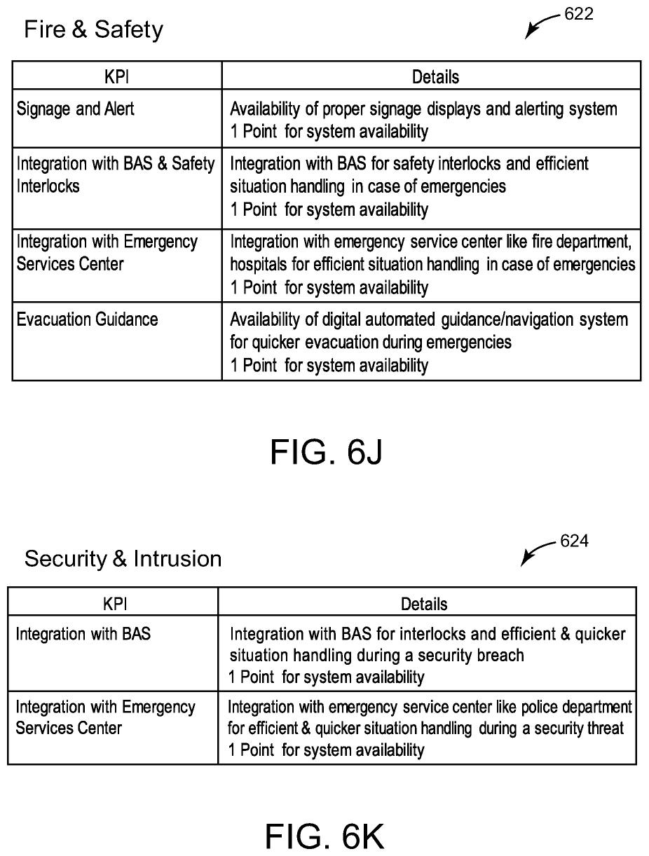

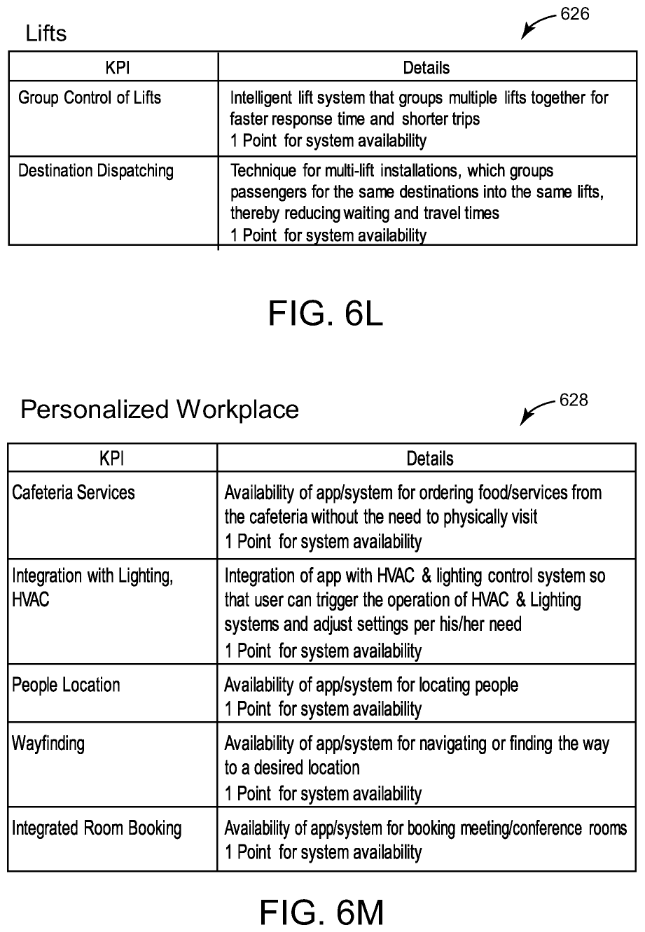

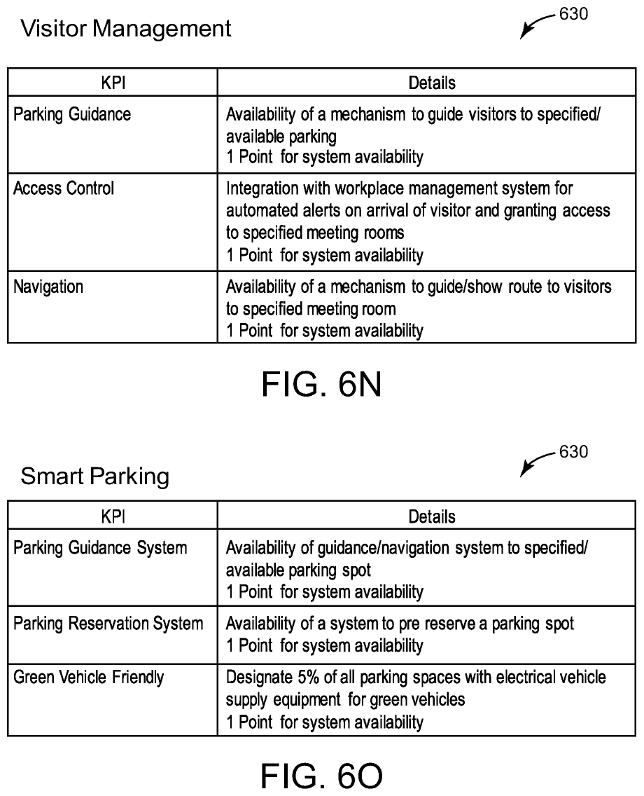

Performance evaluator 518 can determine how many points to associate with each rule for a particular building. Performance evaluator 518 can do so by comparing average values of data over a period of time received and stored by data extractor 514 with different thresholds and/or conditions associated with each rule. Each threshold and/or condition can represent a different point value that can be associated with a characteristic of a building. As will be described below, the point values associated with each rule can be aggregated to receive an aggregated value that represents a smart building score. Examples of different rules within rule database 519, point values, thresholds, and/or conditions associated with each rule are shown and described in reference to FIGS. 6A-O, according to some embodiments.

Referring now to FIG. 6A, an energy use rule table 602 of rule database 519 as described with reference to FIG. 5 is shown representing a number of points associated with the energy use intensity of a building. The rule includes a 14-point scale representing a measurement between the energy use intensity of the building and comparing it to the ASHRAE 100 standard for buildings of the same building type, in some embodiments. Energy use intensity is measured in kBTU/ft²-yr or MJ/m²-yr and can be obtained using analysis of a utility bill, in some embodiments. Energy use rule table 602 may include any number of points based on any percentages of energy use. Data extractor 514 can receive information in a utility bill through user device 536 and store the information in building operation database 517. As the energy performance improves by being below the standard set in the ASHRAE 100, more points are associated with the energy use intensity. For example, if a library has an energy use intensity that is 18% lower than the standard set in the ASHRAE 100, the library can receive 11 points.

Referring now to FIG. 6B, an energy performance rule table 604 of rule database 519 as described with reference to FIG. 5 is shown. Energy performance rule table 604 includes a two-point scale based on whether the building includes load type sub metering and/or system type sub-metering for individual energy loads that consume at least 10% of the total annual consumption of the building, in some embodiments. If the building includes just a load type sub metering, one point can be associated with this rule. If the building includes load type sub metering and system type sub metering, two points can be associated with this rule. There can be any number of c rules related to energy performance.

Referring now to FIG. 6C, an indoor environment quality rule table 608 of rule database 519 as described with reference to FIG. 5 is shown. Rule table 608 includes rules related to space temperature, % relative humidity, carbon dioxide level, light level, PM 2.5 measurement, and carbon monoxide in parking rules, in some embodiments. There can be any number of rules related to indoor environment quality. Each of these rules can provide a binary point value where a point can be awarded if the building meets the criteria of the rule, and a point is not provided if the criteria is not met. For example, the space temperature, % relative humidity, and carbon dioxide level can all be tracked against ASHRAE 55 to determine if they meet the standard in ASHRAE 55. The light level of the building can be tracked against an IE SNA standard. OM 2.5 measurement can be tracked against the air quality standard from the EPA. Carbon monoxide in the parking lot can be tracked against a standard provided by ASHRAE 62.1. Different sensors can measure values related to each of these rules and transmit them to data extractor 514 which can store the values in building operation database 517.

Referring now to FIG. 6D, a renewable energy rule table 610 of rule database 519 as described with reference to FIG. 5 is shown. Renewable energy rule table 610 includes rules associated with determining what percentage of the energy used in a building is renewable, in some embodiments. For example, four points can be awarded if 5% to 10% of the total energy consumption of a building is renewable. If a smaller portion of the building uses renewable energy, less points will be associated with this rule. There can be any number of rules related to renewable energy.

Referring now to FIG. 6E, a wager management rule table 612 of rule database 519 as described with reference to FIG. 5 is shown. Wager management rule table 612 includes rules associated with determining how much water is used per capita of the occupants of the building and how much of the used water is reused, in some embodiments. Water consumption per capita can be evaluated based on a binary standard where one point can be awarded if the water use adheres to the industry standard and no points are awarded if the water use does not adhere to the industry standard. Points are awarded for water reuse depending on the percentage of water that is reused, in some embodiments. If 50% or lower of the water is reused, one point can be awarded. If between 51% and 100% of the water is reused, two points can be awarded. There can be any number of rules related to water management.

Referring now to FIG. 6F, a space utilization rule table 614 of rule database 519 as described with reference to FIG. 5 is shown. Space utilization rule table 614 includes different rules associated with whether areas are occupied or not and the percentage of the time that they are occupied, in some embodiments. Space utilization can be determined using occupant density, occupied seat percentage, % time meeting room occupied, and % of time occupied. Each of the rules that are shown have binary point values where a point is award if a threshold is met while if it is not met no points are awarded. There can be any number of rules related to space utilization.

Referring now to FIG. 6G, an HVAC rule table 616 of rule database 519 as described with reference to FIG. 5 is shown. HVAC rule table 616 includes rules related to HVAC systems including high side-KW/Tr and Low Side-KW/Tr, in some embodiments. The high side equipment energy measurements can be associated with equipment like the chiller plant, the boiler etc., and compared with ASHRAE 90.1 standards. The low side equipment energy measurements can be associated with equipment like the AHU, RTU, etc., and also be measured against ASHRAE 90.1 standard. More points are awarded the further below the ASHRAE 90.1 standard the measurements are. There can be any number of rules related to HVAC systems.

Referring now to FIG. 6H, A lighting rule table 618 of rule database 519 as described with reference to FIG. 5 is shown. Lighting rule table 618 includes rules related to lighting that can include the light power density, part lighting/dimming, lighting control and/or daylight harvesting. Light power density can be measured against ASHRAE 90.1 standards with one point being given for following the standard and two points being given for being 25% lower than the standard, in some embodiments. If the building has part lighting or dimming features, one point can be awarded. If lighting is available based on occupancy control, a point can be award. Finally, if sufficient skylight is available, a point can be awarded associated with the lighting of the building. There can be any number of rules related to lighting.

Referring now to FIG. 6I, an access control rule table 620 of rule database 519 as described with reference to FIG. 5 is shown. Rule 620 includes rules related to occupancy tracking, identity management, and/or integration with HVAC and lighting, in some embodiments. If there is an occupancy tracking system, a point can be awarded. If there is an identity management system, a point can be awarded. If the building has integrated access control with HVAC and lighting control to access and trigger the operation of HVAC and lighting, a point can be awarded. There can be any number of rules related to access control.

Referring now to FIG. 6J, a fire and safety rule table 622 of rule database 519 as described with reference to FIG. 5 is shown. Fire and safety rule table 622 includes rules related to signage and alert, integration with BAS and safety interlocks, integration with emergency services center, and/or evacuation guidance, in some embodiments. If there are proper signage displays and an alerting system, a point can be awarded. If there is integration with BAS for safety interlocks and efficient situation handling in case of emergencies, a point can be awarded. If there is integration with emergency service center like fire department, hospitals for efficient situation handling in case of emergencies, one point can be awarded. If there is availability of digital automated guidance/navigation system for quicker evacuation during emergencies, a point can be awarded. There can be any number of rules related to fire and safety.

Referring now to FIG. 6K, security and intrusion rule table 624 of rule database 519 as described with reference to FIG. 5 is shown. Rule 624 includes rules related to integration with BAS and integration with an emergency services center, in some embodiments. If there is integration with BAS for interlocks and efficient and quicker situation handling during a security break, a point can be awarded. If there is integration with emergency service center like a police department for efficient and/or quicker situation handling during a security threat, a point can be awarded. There can be any number of rules related to security and intrusion.

Referring now to FIG. 6L, lifts rule table 626 of rule database 519 as described with reference to FIG. 5 is shown. Lifts can be elevators or any other type of transportation system. Rule 826 includes rules related to group control of lifts and destination dispatching, in some embodiments. If there is an intelligent lift system that groups multiple lifts together for faster response time and shorter trips, a point can be awarded. If there is a technique for multi-lift installations, which groups passengers for the same destinations into the same lifts, thereby reducing waiting and travel times, a point can be awarded. There can be any number of rules related to lifts.

Referring now to FIG. 6M, a personalized workplace rule table 628 of rule database 519 as described with reference to FIG. 5 is shown. Personalized workplace rule table 628 includes rules related to cafeteria services, integration with lighting, people location, wayfinding, and/or integrated room booking, in some embodiments. If there is availability of app/system for ordering food/services from the cafeteria without the need to physically visit, a point can be awarded. If there is integration of an application (such as a mobile phone application or a computer application) with HVAC and lighting control systems so that users can trigger the operation of HVAC and lighting systems and adjust settings per his/her need, a point can be awarded. If there is availability of an application or system for locating people, a point can be awarded. If there is availability of an application or system for navigating or finding the way to a desired location, a point can be awarded. If there is availability of an application or system for booking meeting or conference rooms, a point can be awarded. There can be any number of rules related to personalized workplace.

Referring now to FIG. 6N, a visitor management rule table 630 of rule database 519 as described with reference to FIG. 5 is shown. Visitor management rule table 630 includes rules related to parking guidance, access control, and/or navigation, in some embodiments. If there is availability of a mechanism to guide visitors to specified/available parking, a point can be awarded. If there is integration with workplace management system for automated alerts on arrival of visitors and granting access to specified meeting rooms, a point can be awarded. If there is availability of a mechanism to guide/show route to visitors to specified meeting room, a point can be awarded. There can be any number of rules related to visitor management.

Referring now to FIG. 6O, smart parking rule table 632 of rule database 519 as described with reference to FIG. 5 is shown. Smart parking rule table 632 includes rules related to parking guidance systems, parking reservations systems, and/or green vehicle friendly, in some embodiments. If there is availability of a guidance and/or navigation system to specified/available parking spot, a point can be awarded. If there is availability of a system to reserve a parking spot, a point can be awarded. If the system designates 5% of all parking spaces with electrical vehicle supply equipment for green vehicles, a point can be awarded. There can be any number of rules related to smart parking.

Referring again to FIG. 5, after performance evaluator 518 receives the data identified by data identifier 516, performance evaluator 518 can compare the data to rules listed in rule database 519. To determine which rule applies to each data point, performance evaluator 518 can scan the data points identified by data identifier 516 for tags showing the data type and sensor. Performance evaluator 518 can determine which rule to apply to each data point by comparing the data type and sensor tags to a table in a database (not shown) within memory 512. For example, a sensor can sense the carbon dioxide level of a room within a building and data extractor 514 can receive data related to carbon dioxide levels within the room at various points in time. Data identifier 516 can identify the data and tag it with a tag corresponding to the carbon dioxide sensor, a tag indicating the data is related to carbon dioxide, and a time stamp. Performance evaluator 518 can scan the tagged data and identify the data as related to carbon dioxide by scanning the tag and find a rule that corresponds to carbon dioxide data within rule database 519.

Further, performance evaluator 518 can identify different rules associated with different data points at once or closely together. This is an advantage because users at user device 536 can request a smart building score that is determined from an aggregation of scores determined from associating data with multiple different rules.

After performance evaluator 518 determines which rule to apply to each data point, performance evaluator 518 can identify scores associated with each rule in rule database 519 associated with the data. In some embodiments, performance evaluator 518 can apply each rule in rule database 519 to the data identified by data identifier 516. In some embodiments, a user at user device 536 can specify which rules to apply. Performance evaluator 518 can still apply a rule if there is no data related to that specific rule. For example, performance evaluator 518 can apply a rule about carbon dioxide levels when there is not a sensor related to carbon dioxide levels in the building. In some embodiments, performance evaluator 518 will default to awarding zero points associated with the rule when there is not a corresponding data point or sensor.

Some rules have different thresholds that data can be compared to be associated with different point values (e.g. rules related to energy performance, onsite renewable, water management, HVAC, and lighting). These rules can award different point values depending on which threshold the corresponding data meets. For example, a building can be awarded up to 20 points based on the energy use intensity rule associated with energy performance depending on how far below the energy usage intensity of a building is below the ASHRAE 100 standard. Other rules simply award points based on whether the subject of the rule is in the system or not (e.g. rules related to indoor environment quality, water management, space utilization, lighting, access control, fire and safety, security and intrusion, lifts, personalized workplace, workplace management, and smart parking). For example, a building can be awarded a point if automated lighting is available in the building and zero points if automated lighting is not in the building.

Performance evaluator 518 can apply each rule specified by a user at user device 536 to the data about a building received by performance evaluator 518. Performance evaluator 518 can, determine how many points can be awarded for each rule based on the different thresholds and binary options specific to each rule

Because users at user device 536 can identify specific time frames to obtain data, performance evaluator 518 can identify scores for different rules over different time periods. To do so, if a rule looks at numerical value inputs to determine if a score is above a specific threshold, performance evaluator 518 can calculate the average of the data related to the rule over the specific time period and compare the calculated average to the threshold or thresholds in the rule to determine different point values. After determining the values associated with each rule, performance evaluator 518 can send the values to smart score evaluator 520.

In some embodiments, if a rule includes a point determination where whether a point can be awarded or not depends on whether the building has or does not have the subject of the rule, performance evaluator 518 can take the average where a portion of a point is granted for the length of time the building has the subject of the rule. For example, performance evaluator 518 can determine whether to award a point to a building system depending on whether it had occupancy tracking over a six-month period. Occupancy tracking can be worth one point if it is present in the building. If occupancy tracking was added to the building four months into the six-month time period, performance evaluator can award the building 0.66 points. In some embodiments, performance evaluator 518 can only grant a point if the building system has the occupancy tracking available throughout the entire six months and zero points if it is not. In some embodiments, performance evaluator 518 can only award a point if occupancy tracking is available at the end of the time frame.

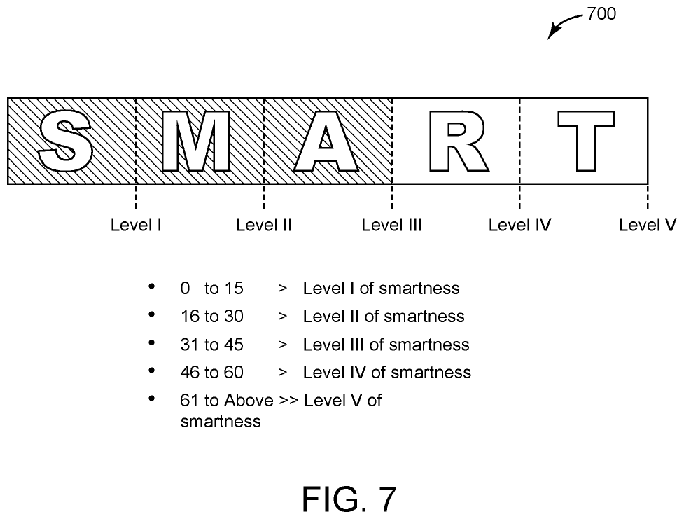

Smart score evaluator 520 can be one component or multiple components within memory 512 that is configured to aggregate the values determined by performance evaluator 518 to obtain an aggregated value, in some embodiments. Smart score evaluator 520 can also generate a smart building score based on the aggregated value. For example, a user at user device 536 can request a smart building score associated with a library for a six-month period. Interface manager 524 can send a signal to data identifier 516 to retrieve all the data from various inputs in the library within the six-month period. Performance evaluator 518 can identify the data and compare the data to rules within rule database 519 to obtain scores associated with different rules. Smart score evaluator 520 can receive the scores and aggregate the scores to generate an aggregated value. After generating an aggregated value associated with data inputs of a building over the selected time period, smart score evaluator 520 can generate a smart building score associated with the building as represented in FIG. 7.

Referring now to FIG. 7, a smart building score bar 700 showing different smart building scores and smart building score thresholds is shown, according to an exemplary embodiment. Smart building score bar 700 can be an interface component that could get integrated into a user interface displayed by user device 536. Smart score evaluator 520 (not shown) can generate a smart building score based on the aggregated value it calculated based on the input time frame set by the user and applying rules to data points within the time frame. Five different levels and thresholds are shown, but there can be any number of levels or thresholds. Further, the smart building score thresholds of 0 to 15 for level 1 smartness, 16 to 30 for level 2 smartness, 31 to 45 for level 3 smartness, 46 to 60 for level 4 smartness and 61 to above for level 5 smartness are examples of different thresholds and ranges for the smart building score, each threshold and range can be any value or range depending on the embodiment.

Smart score evaluator 520 can determine which smart building score threshold to associate with a building for a certain time period by comparing an aggregated value associated with the time period to different smart building score values. For example, applying the example thresholds and ranges above, if the smart score evaluator aggregates the values received from performance evaluator 518 and associated with a building to receive an aggregated value of 42, the smart score evaluator can determine the building has a smartness value of 3. Smart score evaluator 520 can send the smart building score along with all of the data associated with the smart building score to report generator 522.

Referring again to FIG. 5, report generator 522 can be one component or multiple components within memory 512 configured to generate a report to send to web application 526 to display to the user at user device 536, in some embodiments. Report generator 522 can receive data sent from data identifier 516, performance evaluator 518, and smart score evaluator 520 and generate a report showing all of the data including the inputs from building network 502, rules in rule database 519, aggregated scores determined from the rules, and a final smart building score representing how smart a building is. Report generator 522 can create a graphical user interface showing all of the data to display to user device 536 through web application 526. Users at user device 536 can request for components 514-522 to generate reports representing smart building scores for a building for different time periods. Each report can display the time period, the scores associated with each rule and data point, and a final smart building score.

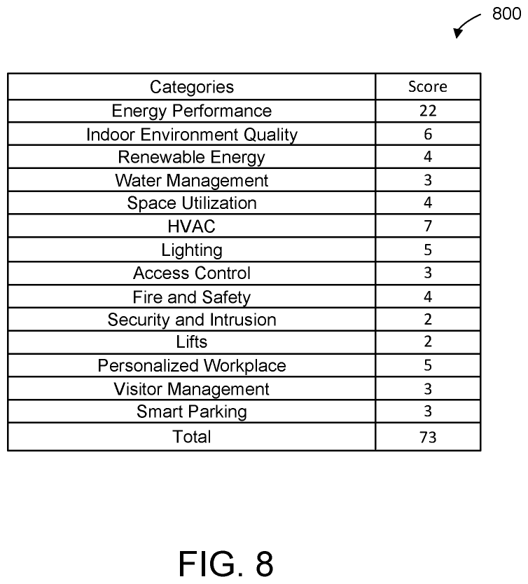

Referring now to FIG. 8, an example report 800 generated by report generator 522 showing scores associated with a performance of a smart building is shown, according to some embodiments via a graphical user interface. Example report 800 can be shown to a user at user device 536 that requests a smart building score for a building. In some embodiments, rules related to a particular aspect of a building can be grouped into a category. Consequently, each score of a rule in a category can be aggregated to obtain an aggregated score of the category. Example report 800 includes multiple categories describing aspects of a building that can be used to determine a buildings smart building score. Examples of categories include energy performance, indoor environment quality, renewable energy, water management, space utilization, HVAC, lighting, access control fire & safety, security & intrusion, lifts, personalized workplace, visitor management, smart parking, etc. Each category is shown to include a score associated with it. Each score can be aggregated to obtain an aggregated scored represented by the total.

Referring back to FIG. 5, memory 512 is shown to include target score identifier 528. Target score identifier 528 can be one component or multiple components configured to identify a target smart building score for a building, in some embodiments. The target smart building score can be set by a user through user device 536 and changed at any time. For example, using the smart levels shown and discussed in reference to FIG. 7 as smart building scores, a user can set a target smart building score to be level 4 smartness using an input to user device 536. Target score identifier 528 can receive the input and set a target smart building score to be between 46 and 60 to obtain level 4 smartness.

A user at user device 536 can request a smart building score from components 514-522 for a time period associated with the previous year. The time period can be any length. Target score identifier 528 can receive a generated smart building score and determine if it is in the range specified by a user as the target smart building score. Using the example shown above, target score identifier 528 can determine if the generated smart building score is at least level 4. In some embodiments, if the generated smart building score is below the target smart building score, target score identifier 528 can send a signal to rule identifier 530 indicating that the building has a low smart building score and how many points need to be added to the smart building score to obtain the target smart building score.

Rule identifier 530 can be one component or multiple components within memory 512 configured to identify rules and categories within rule database 519 associated with a low score, in some embodiments. Rule identifier 530 can also identify rules that can be improved by changing configurations of building equipment within a building associated with the smart building score. Examples of rules and categories that can be identified include, but are not limited to, energy use intensity, space temperature, % relative humidity, light level, PM. 2.5 measurement, carbon monoxide in parking, space utilization, rules related to HVAC equipment, and lighting.

Rule identifier 530 can determine which rules can be improved based on the number of points that need to be awarded to the building to obtain the target smart building score. For example, if target score identifier 528 identifies a target smart building score with a score threshold of 42 points and the current smart building score (or the smart building score calculated from data from the past year) has a point value of 38 points, rule identifier 530 can determine that at least four points can be added to obtain the target smart building score. Rule identifier 530 can scan a report generated by report generator 522 for different rules that can be improved by changing the configurations of building equipment associated with the building associated with the smart building score.

In some embodiments, rule identifier 530 can identify rules with the lowest points compared to the total possible points that can be awarded for a particular rule. For example, a rule can be related to the energy use intensity of a building, which is equal to the total energy used by the building divided by the square footage of the building. The energy use can be worth up to 20 points depending on the energy of the building use compared to a standard set by ASHRAE 100 for similar types of buildings. If performance evaluator 518 determined that the building only earned 4 of the 20 possible points, rule identifier 530 can identify energy use intensity as a rule where more points can be earned instead of a rule such as space temperature, which is only worth one point. Rule identifier 530 can identify any rule as a rule where points can be awarded.

In some embodiments, rule identifier 530 can use user selected thresholds to determine which rules can be improved by changing building equipment configurations. For example, a user can establish a threshold where only rules that can be improved by 3 or more points can be identified as rules where more points can be awarded. The possible rules that rule identifier 530 can identify can be energy use intensity, which can be worth up to 20 points and can be identified if performance evaluator 518 gave it a score of 17 or lower, and HVAC high side-KW/Tr, which can be worth up to four points and can be identified if performance evaluator 518 gave it a score of one or zero, or any other rule that can be improved by up to 3 points. In some embodiments, if the rules identified with a threshold cannot be improved enough to reach the target building score, rule identifier 530 can identify rules iteratively by lowering the threshold one point at a time and identifying rules at each threshold until enough rules have been identified as rules that can be improved. Once rule identifier 530 identifies enough rules that can be improved through building equipment configuration changes, rule identifier 530 can send a signal to configuration tool 532 indicating which rules were identified.

Configuration tool 532 can be one component or multiple components within memory 512 configured to identify new configurations for building equipment based on rules identified by rule identifier 530, in some embodiments. Configuration tool 532 can identify new configurations for building equipment after identifying which pieces of building equipment are associated with the identified rules.

To determine which pieces of building equipment are associated with the identified rules, configuration tool 532 can scan the rules in rule database 519 for tags associated with the building equipment that can impact the rule. Each rule in rule database 519 can have a tag describing building equipment that can be added or configured differently to change inputs associated with the rule. Configuration tool 532 can scan the rules identified by rule identifier 530 to identify these tags and the building equipment that corresponds to the rule. For example, rule identifier 530 can identify a rule related to HVAC energy usage. The rule can have tags identifying different HVAC equipment such as boilers, chillers, etc. Configuration tool 532 can identify the rule and the HVAC devices via the tags associated with the rule. Configuration tool 532 can identify any number of pieces of building equipment associated with any number of rules.

After identifying the building equipment that affects values used to determine points associated with rules, configuration tool 532 can identify new configurations for the building equipment that can improve the points awarded by rules identified by rule identifier 530. For example, if rule identifier 530 identifies energy usage by HVAC devices to be too high according to thresholds within the rule, configuration tool 532 can identify configurations for the HVAC devices where they are used less or utilize less power. In some embodiments, the new configurations can change the function of building equipment so the building equipment cannot perform its function as well, but configuration tool 532 can identify configurations for the building equipment that can enable the building equipment to perform at least a user selected threshold for minimum performance while still increasing how many points it can be awarded for the smart building score.

For example, HVAC devices within a building may not be operating efficiently compared to the standard set in the ASHRAE 90.1 (i.e. the chiller plant and boiler energy consumption is higher than the standards set in the ASHRAE 90.1), because they are heating or cooling rooms and/or water too quickly. Consequently, configuration tool 532 can identify that the devices could be operating more efficiently if they slowed down how quickly the devices heated or cooled the rooms and/or water. Consequently, while the HVAC devices may not operate as effectively, they would operate more efficiently and earn more points for a rule associated with HVAC device efficiency to bring the smart building score of the building closer to a target smart building score.

Signal generator 534 can be one component or multiple components within memory 512 configured to send signals to building network 502 including the new configurations generated by configuration tool 532, in some embodiments. Signal generator 534 can communicate and send the signals to building network 502 through communication interface 505.

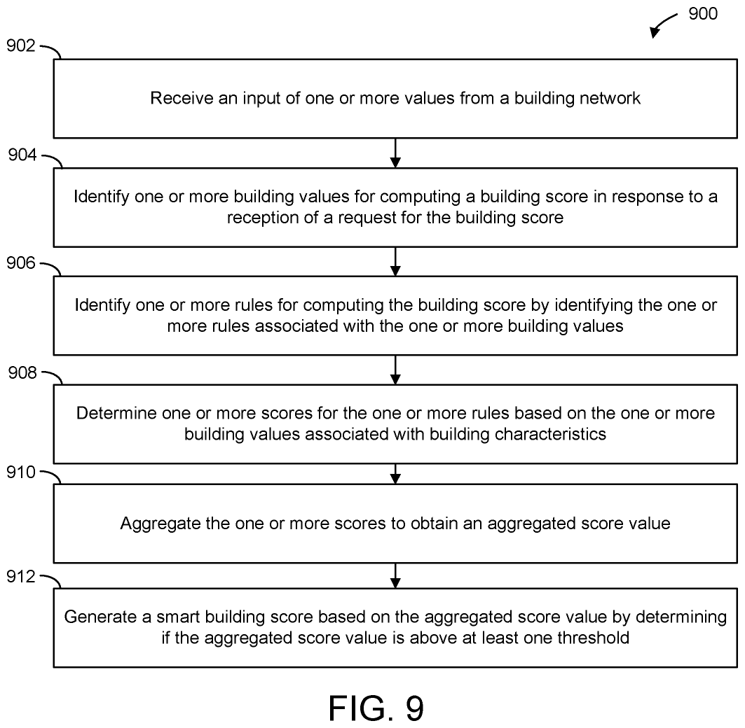

Referring now to FIG. 9, a flow chart showing a process 900 of receiving inputs, associating the inputs with a rule, and generating a smart building score based on the inputs is shown, according to some embodiments. In some embodiments, building scoring system 506 is configured to perform some and/or all of the steps of process 900. Furthermore, any computing device as described herein is configured to perform process 900, in some embodiments. Any computing device, not only building devices, can be configured to perform process 900 of FIG. 9. Process 900 can include more or less steps and is not meant to be limited by this disclosure. For example, process 900 can be performed by components 514-522 within memory 512 shown and described in reference to FIGS. 5, 6A-O, and 9-10. In some embodiments, process 900 is performed in response to a user at user device 536 that inputs a range of dates for which to receive a smart building score. In some embodiments, process 900 can be triggered by an automated process or algorithm to identify building that can change configurations so the building can operate more efficiently.

Process 900 is shown to include receive an input of one or more values from a building network (step 902). In some embodiments, the inputs are received from building network 502, the inputs can include values associated with building characteristics received from various sensors throughout a building. For example, a thermometer can identify the temperature of a conference and can send a value associated with the sensor to building scoring system 506. As building scoring system 506 receives the values from building network 502, building scoring system 506 can store the values in a database within memory 512. In some embodiments, building scoring system 506 can label the data with tags describing which sensors sent the data, what type of data it is, and timestamps indicating when the data was received before adding it to building operation database 517.

Process 900 is further shown to include identify one or more building values for computing a building score in response to a reception of a request for the building score (step 904). In some embodiments, the values are identified by a component within building scoring system 506 after a user at user device 536 inputs a time frame representing a smart building score. Building scoring system 506 can identify values in the database within memory 512 with timestamps within the time frame. Building scoring system 506 can identify all of the data associated with the time frame. In some embodiments, instead of seeking a smart building score, a user can seek data pertaining to specific aspects of a building, such as energy usage of HVAC devices. In these embodiments, a user at user device 536 can identify which aspects of a building to obtain information about and for which time frame. In these embodiments, building scoring system can retrieve the relevant data using time stamp tags and tags identifying types of the data.

Process 900 is further shown to include identify one or more rules for computing the building score by identifying the one or more rules associated with the one or more building values (step 906). Rules associated with a smart building score can be stored in a database within memory 512. After retrieving the values relevant to the time period, building scoring system 506 can identify rules that are associated with each piece of data. Building scoring system 506 can identify rules by using tags on the rules indicating which data is associated with each rule. For example, a rule associated with determining the percentage of time a seat is occupied can be tagged with a tag associated with a sensor that identifies when an object is in the seat. Each rule can be tagged with tags associated with pieces of building equipment.

Process 900 is further shown to include determine one or more scores for the one or more rules based on the one or more building values associated with building characteristics (step 908). Scores associated with each rule can be determined based on whether a building value meets a condition and/or threshold, each condition associated with a particular range or value of the building values. Rules can have any number of conditions and can be worth any number of points. In some embodiments a condition can be whether a building has a system or not. In some embodiments, a condition is similar to a threshold where values can be above or a value associated with the condition. Each rule can have different thresholds and/or conditions associated with each value, where if a value is above a condition and/or threshold, the rule can be worth points associated with the threshold. Rules can have any number of conditions and/or thresholds worth any amount of points. The conditions, thresholds, and points can be determined based on a user input at user device 536. In some embodiments, the user can be an administrator that can change the point values, conditions, and thresholds of the building analytics system at any time.

Process 900 is shown to include aggregate the one or more scores to obtain an aggregated score value (step 910). Building scoring system 506 can aggregate any number of scores depending on which scores are requested to be included in a smart building score report by a user at user device 536. Each score can be identified after building scoring system 506 determines a score for different characteristics of a building using building scoring system 506 to determine how efficient and “smart” the building is. To aggregate the values, building scoring system 506 can identify each score determined in step 908 and add up each identified score.

Process 900 is also shown to include generating a smart building score based on the aggregated value by determining if the aggregated score value is above at least one threshold (step 912). After obtaining an aggregated score value, building scoring system 506 can compare the aggregated value to different user set thresholds to obtain a smart building score representing how “smart” a building is, or how the building operates compared to other buildings of a similar type. Users may set the thresholds to be any value. In some instances, a building score may be above more than one user set threshold. In these instances, building scoring system 506 can identify the smart building score to be a threshold associated with the highest value.

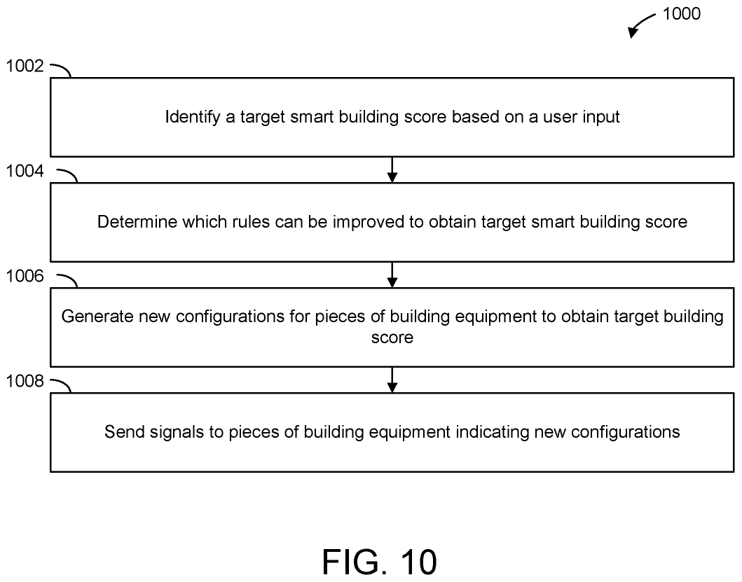

Referring now to FIG. 10, a flow chart showing a process 1000 of using a smart building score to generate new configurations for different pieces of building equipment is shown, according to some embodiments. In some embodiments, building scoring system 506 is configured to perform some and/or all of the steps of process 1000. Furthermore, any computing device as described herein is configured to perform process 1000, in some embodiments. Any computing device, not only building devices, can be configured to perform process 1000 of FIG. 7. Process 1000 can include more or less steps and is not meant to be limited by this disclosure. For example, process 1000 can be performed by components 528-534 within memory 512 shown and described in reference to FIGS. 5, 6A-O, and 7-8. In some embodiments, process 1000 is performed after building scoring system 506 determines a smart building score that is lower than a user selected target smart building score. In some embodiments, process 1000 can be triggered by an automated process or algorithm to identify building equipment that can change configurations so the building can operate more efficiently.

FIG. 10 is shown to include determine a target smart building score based on a user input (step 1002). Building scoring system 506 can determine a target smart building score after receiving an input from a user at user device 536 including a target smart building score. The input can identify the target smart building score from a list of scores such as those shown in FIG. 8. When identifying the target building score, building scoring system 506 can identify a minimum threshold of points needed to reach the target smart building score.

FIG. 10 is further shown to include determine which rules can be improved to obtain target smart building score (step 1004). Building scoring system 506 can determine which categories and rules can be improved by identifying categories and rules that have a high potential for improvement (i.e. where there is a large difference between a maximum score for the rule and a buildings current score for the rule). Building scoring system 506 can use thresholds to determine large differences where a rule can be identified if the points associated with it can be improved above a user selected threshold.

FIG. 10 is further shown to include determine new configurations for pieces of building equipment to obtain a target building score (step 1004). Building scoring system 506 can determine new configurations for pieces of building equipment after identifying the building equipment tagged on any determined rules. For example, a rule associated with HVAC equipment data can be tagged with HVAC equipment tags. Building scoring system 506 can identify the rule and the equipment associated with the building equipment tags and building scoring system 506 can identify new configurations for the building equipment so the building equipment can operate to obtain more points.

FIG. 10 is further shown to include send signals to pieces of building equipment indicating new configurations (step 708). Building scoring system 506 can send signals to building network 502 indicating new configurations for equipment that was identified by building scoring system 506 that will improve a smart building score associated with a building.

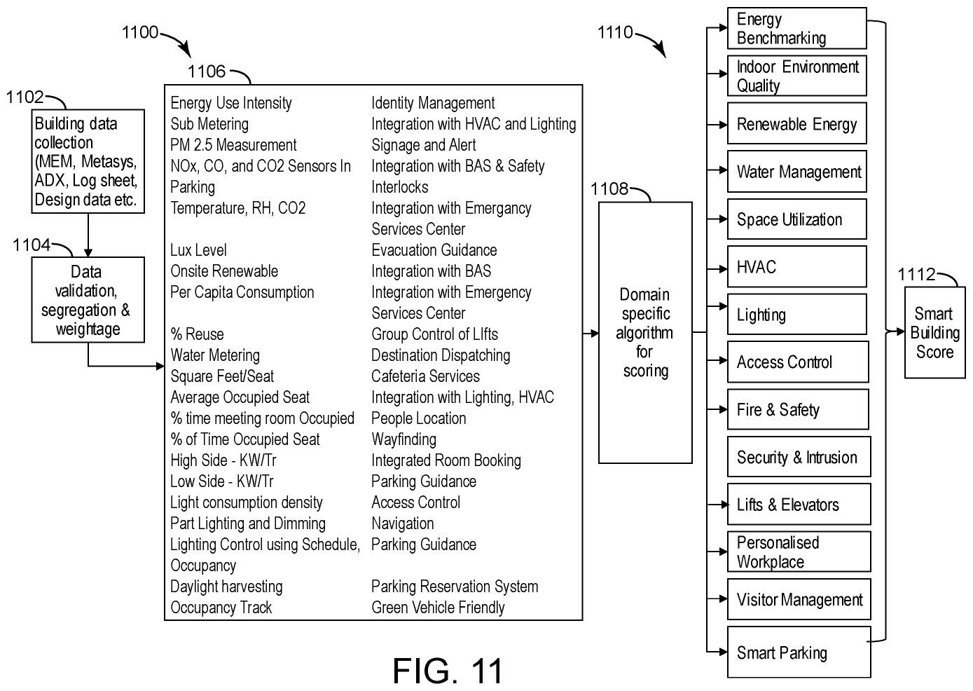

Referring now to FIG. 11, an example flow diagram 1100 of a process with different steps that building scoring system 506 can use to obtain a smart building score is shown, according to some embodiments. Flow diagram 1100 includes building data collection 1102, rule weightage 1104, example characteristics 1106, algorithm 1108, rules 1110, and smart building score 1112. Components 1102-1112 within flow diagram 1100 can be used in any order and contain any number of components and are not meant to be limited by this disclosure.

Building data collection 1102 can be a step conducted by building scoring system 506 dedicated to receiving data associated with characteristic inputs (e.g. temperature, air flow readings, occupancy readings, etc.) and storing the data in a database in building scoring system 506. The data can be collected and stored in MEM, Metasys, ADX, Logsheet, design data, etc.

Rule weightage 1104 can be a step conducted by building scoring system 506 dedicated to ensuring the data is valid, tagging the data within the data in building scoring system with tags indicating when the data was received, the sensor it was received from, and which rule it is associated with, and the weight of the associated rule. For example, the average temperature of a building can be a rule worth 10 if the average temperature is at or below 70 degrees.

Example characteristics 1106 can be characteristics of data inputs that are received by building scoring system 506. Each characteristic can be associated and tagged with a different rule, or rules can be tagged with characteristics.

Algorithm 1108 includes a domain specific algorithm for scoring that building scoring system 506 applies to determine a smart building score represented as smart building score 1112. Building scoring system 506 can apply the weighted rules to the data related to the characteristics listed as examples in example characteristics 1106 to determine a smart building score. Examples of rules used are shown in rules 1110.

Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps can differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for a building analytics system of a building, the method comprising:
receiving, by a processing circuit, an input comprising a plurality of building values from a building network, wherein each value of the plurality of building values is associated with one of a plurality of building characteristics;
identifying, by the processing circuit, a plurality of rules based on the plurality of building values, wherein each of the plurality of rules is associated with one of the plurality of building characteristics;
determining, by the processing circuit, a plurality of scores based on the plurality of rules and the plurality of building, values, wherein each score of the plurality of scores is associated with one of the plurality of building characteristics; and
generating, by the processing circuit, a building score based on the plurality of scores, wherein the building score identifies a performance level of the building.

2. The method of claim 1, wherein the plurality of characteristics includes at least one of energy performance, indoor environment quality, renewable energy, water management, space management, HVAC, lighting, access control, fire and safety, security and intrusion, lifts, visitor management, or smart parking.

3. The method of claim 1, wherein each rule of the plurality of rules is tagged with a building equipment tag representing one of the plurality of building characteristics, wherein each of the plurality of building characteristics is associated with a particular equipment system of the building.

4. The method of claim 1, wherein each value of the plurality of values is associated with an adjustable time period.

5. The method of claim 4, wherein identifying the plurality of scores is based on average values associated with the adjustable time period.

6. The method of claim 1, wherein generating, by the processing circuit, the building score based on the plurality of scores includes:
aggregating, by the processing circuit, the plurality of scores to determine an aggregated score value; and
generating, by the processing circuit, the building score based on the aggregated score value by comparing the aggregated score value to one or more thresholds.

7. The method of claim 6, wherein generating the building score based on the aggregated score value by comparing the aggregated value to the one or more thresholds includes determining whether the aggregated value is below a second threshold of the one or more thresholds;
wherein the method includes:
identifying, by the processing circuit, a portion of the plurality of rules to improve to obtain higher second values associated with each second rule;
identifying, by the processing circuit, configurations for one or more pieces of building equipment associated with the portion of the plurality of rules so the aggregated value is above the at least one second threshold, wherein the one or more pieces of building equipment are identified based on building equipment tags associated with the portion of the plurality of rules; and
generating, by the processing circuit, a signal to transmit to the building equipment comprising the configuration of each piece of building equipment.

8. The method of claim 1, wherein each rule of the plurality of rules includes a plurality of conditions, each condition associated with a particular range or value.

9. The method of claim 8, wherein determining, by the processing circuit the plurality of scores includes:
identifying, by the processing circuit, each condition for each rule of the plurality of rules;
identifying, by the processing circuit, building values associated with each condition; and
determining, by the processing circuit, which conditions have been met for each rule of the plurality of rules based on the identified conditions and building values.

10. A building analytics system of a building, the system comprising a processing circuit configured to:
receive an input comprising a plurality of building values from a building network, wherein each value of the plurality of building values is associated with one of a plurality of building characteristics;
identify a plurality of rules based on the plurality of building values, wherein each of the plurality of rules is associated with one of the plurality of building characteristics;
determine a plurality of scores based on the plurality of rules and the plurality of building values, wherein each scone of the plurality of scores is associated with one of the plurality of building characteristics; and
generate a building score based on the plurality of scores, wherein the building score identifies a performance level of the building.

11. The building analytics system of claim 10, wherein the plurality of characteristics includes at least one of energy performance, indoor environment quality, renewable energy, water management, space management, HVAC, lighting, access control, fire and safety, security and intrusion, lifts, visitor management, or smart parking.

12. The building analytics system of claim 10, wherein each rule of the plurality of rules is tagged with a building equipment tag representing one of the plurality of building characteristics, wherein each of the plurality of building characteristics is associated with a particular equipment system of the building.

13. The building analytics system of claim 10, wherein each value of the plurality of values is associated with an adjustable time period.

14. The building analytics system of claim 13, wherein the processing circuit identifies the plurality of scores based on average values associated with the adjustable time period.

15. The building analytics system of claim 10, wherein the processing circuit generates the building score by:
aggregating the plurality of scores to determine an aggregated score value; and
generating the building score based on the aggregated score value by comparing the aggregated score value to one or more thresholds.

16. The building analytics system of claim 15, wherein the processing circuit generates the building score by determining whether the aggregated value is below a second threshold of the one or more thresholds, and wherein the processing circuit is configured to:
identify a portion of the plurality of rules to improve to obtain higher second values associated with each second rule;
identify configurations for one or more pieces of building equipment associated with the portion of the plurality of rules so the aggregated value is above the at least one second threshold, wherein the one or more pieces of building equipment are identified based on building equipment tags associated with the portion of the plurality of rules; and
generate a signal to transmit to the building equipment comprising the configuration of each piece of building equipment.

17. The building analytics system of claim 10, wherein each rule of the plurality of rules includes a plurality of conditions, each condition associated with a particular range or value.

18. The building analytics system of claim 17, wherein the processing circuit determines the plurality of scores by:
identifying each condition for each rule of the plurality of rules;
identifying building values associated with each condition; and
determining which conditions have been met for each rule of the plurality of rules based on the identified conditions and building values.

19. A non-transitory computer-readable storage medium having instructions stored thereon that, upon execution by a processor, cause the processor to perform operations to generate a building score, the operations comprising:
receiving an input comprising a plurality of building values from a building network, wherein each value of the plurality of building values is associated with one of a plurality of building characteristics;
identifying a plurality of rules based on the plurality of building values, wherein each of the plurality of rules is associated with one of the plurality of building characteristics;
determining a plurality of scores based on the plurality of rules and the plurality of building values, wherein each score of the plurality of scores is associated with one of the plurality of building characteristics; and
generating a building score based on the plurality of scores, wherein the building score identifies a performance level of the building.

20. The non-transitory computer-readable storage medium of claim 19, wherein the processor generates the building score by determining whether the aggregated value is below a second threshold of the one or more thresholds; and wherein the operations include:
aggregating the plurality of scores to determine an aggregated score value; and
generating the building score based on the aggregated score value by comparing the aggregated score value to one or more thresholds;
identifying a portion of the plurality of rules to improve to obtain higher second values associated with each second rule;
identifying configurations for one or more pieces of building equipment associated with the portion of the plurality of rules so the aggregated value is above the at least one second threshold, wherein the one or more pieces of building equipment are identified based on budding equipment tags associated with the portion of the plurality of rules; and
generating a signal to transmit to the building equipment comprising the configuration of each piece of building equipment.
